(19) United States
(12) Patent Application Publication
(10) Pub. No.: US 2009/0161682 A1
(43) Pub. Date: Jun. 25, 2009

(54) Managing Bandwidth during a Contention Free Period in a LAN

(75) Inventors: Jed Johnson, Cataumet, MA (US); Gordon Beacham, San Diego, CA (US); Robert Litwak, Perkasie, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/962,905

(22) Filed: Dec. 21, 2007

(51) Int. Cl. H04L 12/66; H04J 3/16

(52) U.S. Cl. 370/401; 370/468

(57) ABSTRACT

Bandwidth for a contention free period in a LAN is managed using an access control list. A request for bandwidth during the contention free period is received. A determination is made as to whether to grant the request for bandwidth based on the access control list.

### BACKGROUND

Some local area network (LAN) technologies, such as MOCA, HomePNA, HomePlug and WiFi using WMM-SA, use contention free periods and contention periods to manage bandwidth. The contention free period is the period of time when more than one device or more than one software application desires to access the same network resource at the same time, and access to the resource is managed. The resource might be bandwidth, and bandwidth may be managed by scheduling times when devices can communicate on the LAN. Access to the resource is managed to improve quality of service (QoS). For example, in WiFi, during the contention free period, an access point sends contention free-poll packets to each device or station, one at a time, to give them the right to send a packet. The access point is the coordinator, which allows for a better management of the QoS in the wireless LAN.

During the contention period, a device on the LAN gains access to the medium, for example, on a first-come-first-serve basis, and there is little or no QoS management during this period. During the contention period, an ill behaved device can attempt to continuously dominate the medium by attempting to transmit continuously, and all other devices that need to transmit during the contention free period will suffer. It should be noted that in many protocols, a percentage of the total bandwidth is allocated for the contention period and the remaining percentage of the total bandwidth is allocated for the contention free period.

LANs that provide a contention free period for applications and devices to reserve bandwidth generally do not have a mechanism to prevent devices from reserving more bandwidth than they need, or utilizing more bandwidth than they reserved. Admission control mechanisms do not discriminate among devices, allowing any device equal access. In certain situations, service providers may require a certain QoS to deliver services via the LAN. For example, a cable service provider may provide a subscription or premium service that requires certain QoS reservations. Examples of these services may include VoIP or IPTV. In many situations, the QoS reservations are achieved during the content free period but not during the contention period. However, during the contention free period other devices could be granted access to reserved bandwidth to the extent that the service deliberated by the cable service provider suffers. For example, during contention free periods a device that is only operable to transmit at 1 Mbps may request 10 Mbps and get the 10 Mbps. As a result, other applications and devices attempting to get bandwidth during the contention free period suffer.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a system, according to an embodiment;

FIG. 2 illustrates flow chart of a method for managing bandwidth in a contention free period, according to an embodiment; and

FIG. 3 illustrates a block diagram of a computing platform, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

According to an embodiment, a QoS manager determines the devices that are given access to bandwidth in a LAN during a contention free period. The contention free period is a period of time when scheduled access to a network resource, such as bandwidth in the LAN transmission medium, is given. In one embodiment, the contention free period is comprised of time slots assigned to devices or applications requesting transmission during the contention free period. A contention period may also be provided where access to bandwidth is unscheduled.

An access control list may be used by the QoS manager to identify the devices and applications that are approved to have scheduled access to the LAN transmission medium during the contention free period. For example, the access control list may identify the approved devices. The devices may be approved by a service provider and/or a user. Thus, devices determined to consume excessive bandwidth during the contention free period to the detriment to a service provided by a service provider may not be included in the access control list.

The access control list may comprise a white list, a black list or both. The white list identifies the devices approved for scheduled access to bandwidth during the contention free period. The black list identifies devices not approved for scheduled access to bandwidth during the contention free period. The lists may be manually or dynamically populated.

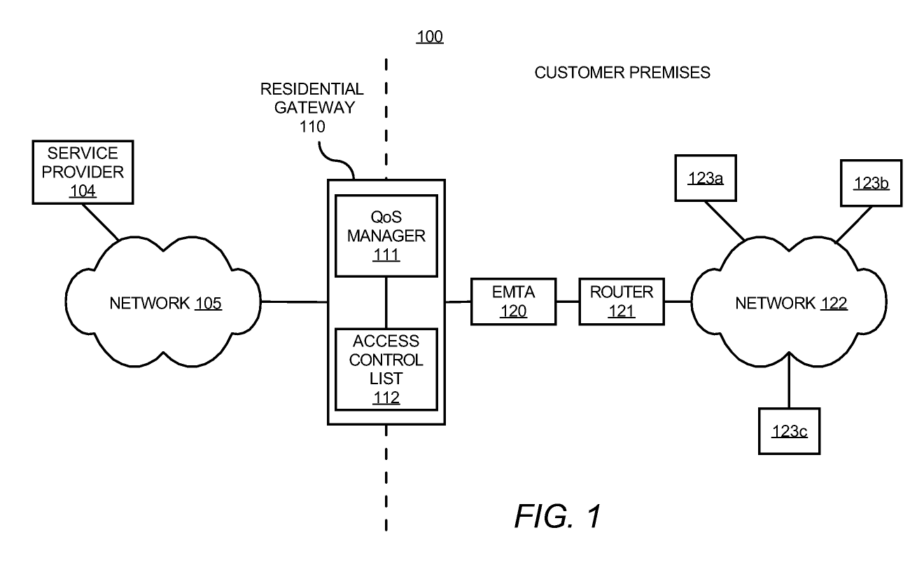

FIG. 1 illustrates a system 100, according to an embodiment. The system 100 includes a customer premises with a residential gateway 110. The residential gateway 110 may be any hardware, software, or combination of hardware and software capable of receiving signals from a service provider and rendering those signals suitable for a user device. For example, the residential gateway 110 may receive signals and/or physical wiring carrying signals from a cable service provider, telephone service provider, high-speed Internet provider, etc. Generally, service providers transmit a complex digital signal over fiber, copper, etc., to the residential gateway 110. Devices at the customer premises, referred to as customer premised equipment (CPE), typically cannot effectively interpret this complex signal. Thus, the residential gateway 110 may convert these complex digital signals into a format that the CPE may utilize. CPE may include a telephone, a set-top-box, a router, etc, which receives signals and provides services to the user. The residential gateway 110 may contain any appropriate outputs, such as telephone jacks, cable ports, Ethernet ports, etc. Therefore, the residential gateway 110 operates as an interface between service providers and user devices.

The residential gateway 110 is connected to a network 105 outside the customer premises. The residential gateway 110 may receive telephone, cable television, Internet services, etc., from various service providers, and the service providers may be connected to the residential gateway 110 via the network 105. The network 105 represents one or more networks, such as a public switched telephone network (PSTN), a cable network, a satellite network, etc. A service provider 104 may include a cable service provider, satellite service provider, telephone service provider, etc. Although not shown, multiple service providers may provide services to multiple customer premises via the network 105.

The customer premises may include CPE connected to the network 105 via the residential gateway 110. The CPE may include a modem or embedded multimedia terminal adapter (EMTA) 120, a router 121, a network 122, and one or more devices 123a-c connected to the network 122. The network 122 may include a wired or a wireless LAN. The devices 123a-c may include computers, set top boxes, etc.

According to an embodiment, the residential gateway 110 includes a QoS manager 111 that regulates scheduled access to bandwidth (throughput) during a contention free period. The QoS manager 111 regulates the scheduled access to bandwidth during the contention free period using an access control list 112. The QoS manager 111 uses the access control list 112 to identify devices or applications that will be given scheduled access to bandwidth during the contention free. The access control list 112 may be a data structure stored in memory or other storage device, and includes identification information for identifying devices on the access control list. The QoS manager 111 may include software, hardware or a combination of both. In one embodiment, the QoS manager 111 includes software residing on the residential gateway 110 and operable to perform the functions described herein.

The access control list 112 may comprise a white list, a black list or both. The white list identifies the devices approved for scheduled access to bandwidth during the contention free period. The black list identifies devices not approved for scheduled access to bandwidth during the contention free period. The lists may be manually or dynamically populated.

The access control list may be populated by one or more service providers, such as the service provider 104, and if permitted, the service subscriber. A service provider typically can identify the devices that it provides to the user for use at the customer premises. The service providers' devices are identified in the access control list 112. For example, the service provider 104 is a cable service provider that provides high-speed Internet service, cable TV service and voice over IP (VoIP) service. The service provider 104 provides the EMTA 120 and devices 123a and 123b (e.g., set top boxes) to the user. The service provider 104 stores identification information (e.g., serial number, MAC address, etc.) for the EMTA 120 and the devices 123a and 123b. The identification information is transmitted to the residential gateway 110, and the QoS Manager 111 stores the identification information for the EMTA 120 and the devices 123a and 123b in the access control list 112.

In this example, the access control list includes a white list, and the QoS Manager 111 only schedules bandwidth during the contention free period for devices on the access control list. A black list may also be provided, and the QoS Manager 111 excludes any devices on the black list from getting bandwidth during the contention free period. Devices not given bandwidth during the contention free period may get bandwidth during the contention period.

The access control list 112 may be dynamically and automatically populated when IP addresses are assigned. For example, the network 122 is an IP network. The devices 123a-c use a protocol, such as Dynamic Host Configuration Protocol (DHCP), to obtain various parameters necessary for the clients to operate in the network 122. When the devices 123a-c connect to the network 122, their DHCP clients send requests to a DHCP server, which may be the router 121, for IP addresses for use in the network 122. The DHCP server assigns the IP addresses. According to an embodiment, the DHCP server may request additional information about each of the devices 123a-c. This additional information is used by the QoS manager 111 to determine whether the devices will be given bandwidth during the contention free period.

For example, the additional information requested by the DHCP server may include MAC address, serial number, manufacturer, device description, etc. This additional information is sent to the QoS manager 111. The service provider 104 may request this additional information from the QoS manager 111 to determine whether these devices will be problematic rogue devices or approved devices. Based on these determinations, the devices 123a-c may be placed on a black list or a white list in the access control list 112. A user may also determine whether the devices 123a-c may be placed on a black list or a white list in the access control list 112.

Devices not approved by a user or service provider may be provided on a black list. In one example, the network 122 is left alone until something goes wrong. For example, the service provider 104 receives a user complaint that a streaming media service provided by the service provider 104 is not working. The router 121 identifies all the devices 123a-c connected to the network 122. The QoS manager 111 provides the list to the service provider 104. The service provider 104 identifies the devices that are not for providing the service and eliminates the devices from the contention free period by including them on the black list.

The black list could be created a number of other ways including the following: (1) the residential gateway 110 can discover devices connected to the network 122 and display them in a list, and a user (e.g., service subscriber) could pick from the list; (2) a service provider could use the same discovery mechanism and pick from the list; and (3) events identifying a rogue device could be used to create a black list. These events might include discovery of mismatched traffic patterns versus an allowed QoS policy. One mechanism to identify the proper policy holder service would be to correlate the IP address of a Universal Plug and Play (UPnP) Internet Gateway Device (IGD) service since the proper policy holder service should be running on the residential gateway 110 which would also be running the IGD service. Other network behavior could be also be used. These events could be trapped by an application running on the residential gateway 110 or a set top box or they could be reported using TR69 or simple network management protocol. This same approach could be used to drive the same system using a white list instead of a black list.

In one embodiment, the QoS manager 111 is a QoS manager in a UPnP architecture. UPnP QoS is a standard for QoS management in home networks. The UPnP QoS 1.0 and 2.0 standards specify a policy holder service where more than one policy holder is allowed. Thus, any device on the network 122 can host its own policy holder service and service whatever policy it wants. For service providers that want to offer a controlled and deterministic network behavior, this approach is not acceptable. For example, the service provider 104 provides a streaming media service for the device 123a, and the device 123c hosts a policy holder service that allows it to get excessive bandwidth during the contention free period, which results in a degradation of the streaming media service.

According to an embodiment, the QoS manager 111 in the residential residential gateway 110 hosts a policy holder service that has priority over any other policy holder service which may be running on different devices in the network 122. Also, the policy holder service provided by the QoS manager 111 may be controlled at least in part by a service provider. For example, the policy holder service provided by the QoS manager 111 includes instructions for the QoS manager 111 to use the access control list 112 to determine whether a device is provided with scheduled bandwidth during the contention free period. Also, the service provider 104 may provide or regulate which devices are on the access control list 112. Thus, the service provider is provided with means to control QoS within a home or customer network to improve delivery of services.

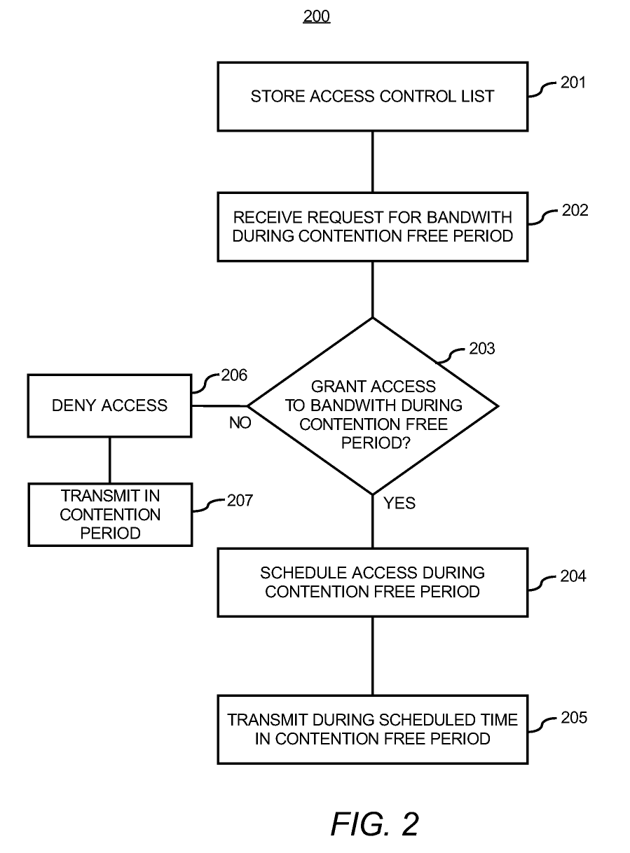

FIG. 2 illustrates a flow chart of a method 200 for managing QoS in a contention free period for a LAN. The method 200 is described with respect to the system 100 shown in FIG. 1 by way of example and not limitation. The method 200 may be practiced in other systems.

At step 201, an access control list is stored. For example, the access control list 112 is stored in the residential gateway 110 and used by the QoS manager 111 to regulate scheduled access to bandwidth during the contention free period. The access control list may comprise one or more of a black list, a white list or both.

At step 202, a request for bandwidth during the contention free period is received. For example, the QoS manager 111 receives requests to communicate during the contention free period from devices 123a-c. The requests may be received in response to a polling of the devices or may be broadcasted by the devices without polling.

At step 203, a determination is made, using the access control list, as to whether the device is allowed to be provided with scheduled access to bandwidth during the contention free period. For example, the QoS manager 111 determines whether the devices 123a-c are on a white list or a black list in the access control list 112. Devices on the white list are given scheduled access to bandwidth during the contention free period. Devices on the black list are not given scheduled access to bandwidth during the contention free period and may only transmit during the contention period. Devices not on a white list or a black list may provisionally be given scheduled access to bandwidth during the contention free period until a problem arises or until approved by a user or service provider. At step 203, the QoS Manager 111 identifies a device sending a request for bandwidth, and parses the access control list to determine whether the device is approved for bandwidth during the contention free period.

If the determination at step 203 indicates that the device is allowed to be given scheduled access to bandwidth during the contention free period, the device is given scheduled bandwidth, such as one or more time slots, during the contention free period at step 204. At step 205, the device transmits during the scheduled time in the contention free period. Otherwise, at step 206, the device is denied access to bandwidth during the contention free period and is delegated to transmission on the network 122 during the contention period at step 207.

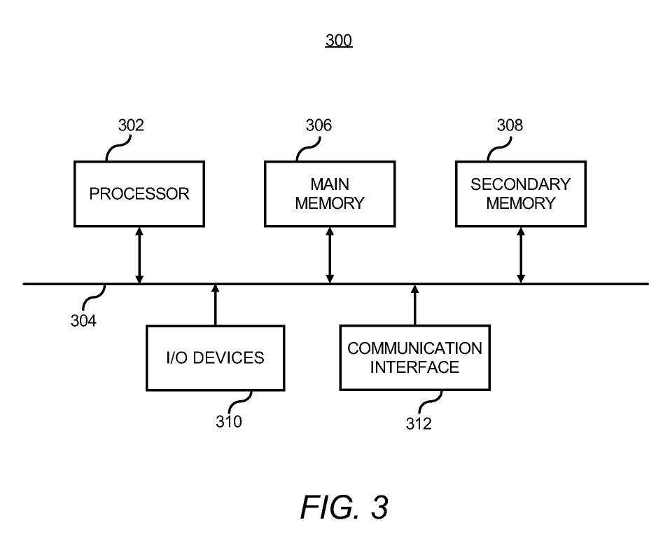

FIG. 3 illustrates a block diagram of a general purpose computer system 300 that represents a platform for one or more of the components of the system 100 described above. Components may be added or removed from the general purpose computer system 300 to provide the desired functionality.

The computer system 300 includes processor 302 providing an execution platform for executing software. Commands and data from the processor 302 are communicated over a communication bus 304. The computer system 300 also includes a main memory 306, such as a Random Access Memory (RAM), where software may reside during runtime, and a secondary memory 308. The secondary memory 308 includes, for example, a hard disk drive and/or a removable storage drive representing a floppy diskette drive, a magnetic tape drive, a compact disk drive, etc., or a nonvolatile memory where a copy of the software is stored. In one example, the secondary memory 308 also includes ROM (read only memory), EPROM (erasable, programmable ROM), EEPROM (electrically erasable, programmable ROM). The computer system 300 includes I/O devices 310. The I/O devices 310 may include a display and/or user interfaces comprising one or more I/O devices 310, such as a keyboard, a mouse, a stylus, and the like. However, the I/O devices 310 are optional as well as other shown components. A communication interface 312 is provided for communicating with other computer systems. The communications interface 312 may facilitate connection to one or more networks.

In one embodiment, the computer system 300 represents a platform for the residential gateway 110 shown in FIG. 1 and hosts software provided the QoS manager 111. The software and access control list 112 may be stored in the main memory 306 and/or the secondary memory 308. The I/O devices 310 may be used by a user to approve, disprove, add or delete devices on the access control list 112. The communications interface 312 may comprise one or more interfaces for communicating with service provider networks, such as the network 105, and an interface for communicating with the network 122. The communications interface 312 may be used by the service provider to communicate the access control list or other information.

One or more of the steps described herein are operable to be implemented as software stored on a computer readable medium, such as the memory 306 and/or 308, and executed on the computer system 300, for example, by the processor 302.

The steps are operable to be embodied by a computer program, which can exist in a variety of forms both active and inactive. For example, they exist as software program(s) comprised of program instructions in source code, object code, executable code or other formats for performing some of the steps. The codes described above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method for managing bandwidth during a contention free period in a local area network (LAN), the method comprising:
storing an access control list;
receiving a request for bandwidth during the contention free period; and
determining whether to grant the request for bandwidth during the contention free period based on the access control list.

2. The method of claim 1, wherein determining whether to grant the request for bandwidth based on the access control list comprises:
identifying a device sending the request for bandwidth; and
parsing the access control list to determine whether the device is approved for bandwidth during the contention free period.

3. The method of claim 2, further comprising:
if the device is approved for bandwidth during the contention free period, scheduling a time during the contention free period for the device to communicate on the LAN; and
if the device is not approved for bandwidth during the contention free period, denying access to bandwidth during the contention free period.

4. The method of claim 1, wherein the access control list comprises a white list, a black list or both the white list and the black list, wherein the white list identifies the devices that are approved to be given scheduled access to bandwidth during the contention free period, and the black list identifies devices that are not to be given access to bandwidth during the contention free period.

5. The method of claim 4, wherein only devices on the white list are given scheduled access to bandwidth during the contention free period.

6. The method of claim 1, further comprising:
populating the access control list with an identification of devices based on a decision of a service provider providing a service via the LAN.

7. The method of claim 6, further comprising:
determining information about devices connected to the LAN when the devices request IP addresses;
providing the information to the service provider;
receiving an indication from the service provider whether each device is approved or not approved for scheduled access to bandwidth during the contention free period; and
identifying each device as approved or not approved for scheduled access to bandwidth during the contention free period on the access control list based on the indications received from the service provider.

8. The method of claim 6, further comprising:
determining whether there is a problem with the service provided via the LAN;
providing information about devices connected to LAN to the service provider;
receiving an identification of each device not provided by the service provider; and
for each device not provided by the service provider, identifying the device as not approved for scheduled access to bandwidth during the contention free period on the access control list.

9. The method of claim 1, further comprising:
populating the access control list with an identification of devices based on a decision of a user having devices connected to the LAN.

10. The method of claim 1, further comprising:
dividing the total bandwidth on the LAN between the contention free period and a contention period, wherein scheduled access to bandwidth is provided for bandwidth in the contention free period and unscheduled access to bandwidth is provided for bandwidth in the contention period.

11. The method of claim 1, further comprising:
automatically detecting devices that are allowed or not allowed to be given bandwidth during the contention free period; and
automatically populating the access control list with the detected devices.

12. A residential gateway providing an interface between service providers and devices at a customer premises, the residential gateway comprising:
a QoS manager;
an access control list stored in data storage; and
interfaces connecting at least one service provider network to a network at the customer premises,
wherein the QoS manager is configured to receive a request for bandwidth during a contention free period from a device connected to the network at the customer premises, and the QoS manager is configured to determine whether to grant the request based on the access control list.

13. The residential gateway of claim 12, wherein the access control list identifies whether devices connected to the network at the customer premises are approved or not approved for scheduled access to bandwidth during the content free period and the devices that are approved or not approved are automatically detected and the access control list is automatically populated with the devices approved or not approved.

14. The residential gateway of claim 13, wherein the service provider approves or does not approve the devices connected to the network at the customer premises for scheduled access to bandwidth during the content free period, and indication of the approval or the non-approval for each device is provided in the access control list.

15. The residential gateway of claim 14, wherein the QoS manager receives information from the devices connected to the LAN when the devices request IP addresses and provides the information to the service provider for determining whether to approve or not approve the devices for scheduled access to bandwidth during the content free period.

16. The residential gateway of claim 14, wherein the QoS manager determines whether there is a problem with the service provided via the LAN and provides information about the devices connected to LAN to the service provider for determining whether to approve or not approve the devices for scheduled access to bandwidth during the content free period.

17. The residential gateway of claim 13, wherein a user of the devices approves or does not approve the devices connected to the network at the customer premises for scheduled access to bandwidth during the content free period.

18. The residential gateway of claim 12, wherein a total bandwidth on the LAN is divided between the contention free period and a contention period, wherein scheduled access to bandwidth is provided for bandwidth in the contention free period and unscheduled access for bandwidth is provided for bandwidth in the contention period.

19. A computer readable medium on which is embedded a computer program, the computer program implementing a method for managing bandwidth during a contention free period in a LAN, the method comprising:
storing an access control list;
receiving a request for bandwidth during the contention free period; and
determining whether to grant the request for bandwidth during the contention free period based on the access control list.

20. The computer readable medium of claim 18, wherein determining whether to grant the request for bandwidth based on the access control list comprises:
automatically detecting devices that are allowed or not allowed to be given bandwidth during the contention free period;
automatically populating the access control list with the detected devices;
identifying a device sending the request for bandwidth during the contention free period; and
parsing the access control list to determine whether the device is approved for bandwidth during the contention free period.
